(19) United States
(12) Patent Application Publication
(10) Pub. No.: US 2016/0275446 A1
(43) Pub. Date: Sep. 22, 2016

(54) APPARATUS AND METHOD FOR DETERMINING HS CODE

(71) Applicants: KOREA TRADE NETWORK, Seoul (KR); IC&;IT, Seoul (KR)

(72) Inventor: Byung Jun SONG, Anyang-si (KR)

(21) Appl. No.: 14/699,079

(22) Filed: Apr. 29, 2015

(30) Foreign Application Priority Data
Mar. 16, 2015 (KR) 10-2015-0036081

(51) Int. Cl. G06Q 10/08; G06F 3/0484; G06F 17/30

(52) U.S. Cl. CPC G06Q 10/0831; G06F 17/30964; G06F 17/30991; G06F 3/04842

(57) ABSTRACT

A method of determining an HS code includes displaying information HS determination factor information that belongs to HS determination factor information and that may be selected by a user, receiving an input of the user for selecting any one of the displayed HS determination factor information, comparing the received input with commodity classification information stored in memory, and displaying a determined HS code if, as a result of the comparison, the HS code is found to be determined and returning back to the step of displaying the selectable information HS determination factor information if, as a result of the comparison, the HS code is found to be not determined.

### CROSS REFERENCE TO RELATED APPLICATION

The present application claims the benefit of Korean Patent Application No. 10-2015-0036081 filed in the Korean Intellectual Property Office on Mar. 16, 2015, the entire contents of which are incorporated herein by reference.

### BACKGROUND OF THE INVENTION

1. Technical Field

The present invention relates to a method of determining an HS code and an apparatus for executing the method and, more particularly, to a method of inducing a user to intuitively determine an HS code and an apparatus for executing the method.

2. Description of the Related Art

An HS means that various commodities transacted all over the world are sorted in a single Harmonized Commodity Description and Coding System (also abbreviated as “Harmonized System (HS)”) HS code based on HS regulated by the World Custom Organization (WCO). In accordance with The International Convention on the Harmonized Commodity Description and Coding System (i.e., HS Convention), a contracting party performs an HS business based on the principle regulated by the HS.

In a custom tariff for an import commodity, import duties to be paid in advance are determined when an accurate HS is present because a custom tariff applied to each HS code has been predetermined. In particular, an HS code is different if a commodity has a similar function, but has a different shape or if a commodity has a similar shape, but has a different function or depending on whether a commodity is a general-purpose part or a dedicated part. In order to pay an accurate tariff, a correct HS is important when making an import declaration.

The HS code is a classification code that is assigned to an import/export commodity according to the HS Convention and is a code that is internationally used up to 6 digits in common. In each country, the HS code can be subdivided within a range of a 6 unit subheading from 7 digits and used up to 10 digits. In Korea, 10 digits are used, which is called HS of Korea (HSK).

For example, in 10-unit HSK, that is, 0102.90-1000, the structure of an HS code is defined as follows:

* 01: Chapter ->Chapter at which live animals are classified, which refer to former 2 digits.

0102: Heading ->Heading at which a cow is classified, which refers to former 4 digits.

* 0102.90: Subheading ->Subheading at which other cows are classified, which refers to former 5 and 6 digits.

* 0102.90-1000=Refer to a 10-digit code at which ┌milk cow┘ is classified. A 7 unit or less may be subdivided and used in each country within a range that is determined in the 6 unit. In Korea, the last 4 digits are subdivided and used as a 10 unit.

A process of searching for an HS code corresponding to a specific commodity is called commodity classification. It is practically very difficult to classify a specific commodity according to the HS code having a hierarchical structure. HS is basically performed according to the general rule of HS of the HS Convention regulated by Customs Cooperation Council (CCC), but is not simply determined depending on the type of commodity and may be changed depending on the major properties, components, use, material, and other factors of a commodity.

If a clearance of import for a specific commodity has been performed based on erroneous commodity classification in accordance with the Customs Law, but the specific commodity is determined to correspond to another HS code, an importer (or taxpayer) bears an economic burden, such as a supplementary collection and an added tax attributable to an error in the HS report.

Accordingly, a specific commodity needs to be accurately classified based on an HS code, but it is not easy to accurately classify a specific commodity based on HS as described above.

### PRIOR ART DOCUMENT

### Patent Document

(Patent Document 0001) Korean Patent Application Publication No. 2012-0052636

### SUMMARY OF THE INVENTION

Accordingly, the present invention has been made keeping in mind the above problems occurring in the prior art, and an object of the present invention is to allow a user to easily search for an HS code although the user does not have expert knowledge of the HS code.

In particular, an object of the present invention is to allow a user to easily select an HS code using an intuitive interface.

In accordance with an embodiment of the present invention, a method of determining an HS code includes the step of displaying information HS determination factor information that belongs to HS determination factor information and that is able to be selected by a user, receiving the input of the user for selecting any one of the displayed HS determination factor information, comparing the received input with commodity classification information stored in memory, and displaying a determined HS code if, as a result of the comparison, the HS code is found to be determined and returning back to the step of displaying the selectable information HS determination factor information if, as a result of the comparison, the HS code is found to be not determined. The connection structure of commodity classification information corresponding to the HS determination factor information may be stored in the memory. The comparison step may include extracting next-order HS determination factor information included in the connection structure of the commodity classification information corresponding to the received HS determination factor information. The display step may include displaying the extracted next-order HS determination factor information.

In this case, the display step may include highlighting and displaying HS determination factor information that belongs to the next-order HS determination factor information and that corresponds to the connection structure. Furthermore, the display step may include displaying the connection structure of the commodity classification information stored in the memory along with the HS determination factor information.

In another embodiment of the present invention, the method may further include the step of matching sequentially received HS determination factor information with the determined HS code and storing the matched HS determination factor information and HS code in the memory if the HS code is determined after the comparison step. In this case, if the HS determination factor information selected in the receiving step does not correspond to the connection structure and the HS code has not been determined, the display step may include highlighting and displaying HS determination factor information that belongs to the HS determination factor information capable of being selected by the user and that has the highest frequency of selection based on the HS determination factor information stored in the memory and the matching information of the HS code.

In another embodiment of the present invention, the display step may include highlighting and displaying HS determination factor information that belongs to the HS determination factor information capable of being selected by the user and that has a small number of pieces of the next-order HS determination factor information. In particular, if the HS determination factor information selected in the receiving step does not correspond to the connection structure, frequency of selection of the HS determination factor information capable of being selected by the user is 0 or identical, and the HS code has not been determined, the display step may include highlighting and displaying HS determination factor information that belongs to the HS determination factor information capable of being selected by the user and that has a small number of pieces of the next-order HS determination factor information.

In another embodiment of the present invention, analogous term information matched with the HS determination factor information may be stored in the memory. The display step may include displaying an analogous term information search item along with the HS determination factor information and displaying HS determination factor information matched by a search word that is input to the analogous term information search item by the user.

The method of determining an HS code in accordance with various embodiments of the present invention may be implemented in the form of a computer-readable recording medium on which a program for executing the method has been recorded or in the form of a computer program that may be stored in a medium for executing the method.

In accordance with an embodiment of the present invention, an apparatus for determining an HS code may include an interface processing unit configured to provide HS determination factor information so that a user is able to select the HS determination factor information, receive selected HS determination factor information from the user, deliver the received HS determination factor information to a processor or memory, and provide HS determination factor information or an HS code processed by the processor in a form in which the HS determination factor information or HS code is capable of being checked by the user, the processor configured to compare the HS determination factor information received from the interface processing unit with commodity classification information stored in the memory, calculate next-order HS determination factor information or HS code corresponding to the received HS determination factor information, and deliver the calculated next-order HS determination factor information or HS code to the interface processing unit or the memory, and the memory configured to store a commodity classification connection structure corresponding to the HS determination factor information and an HS code corresponding to the connection structure.

### BRIEF DESCRIPTION OF THE DRAWINGS

FIG. 1 is a flowchart illustrating a method of determining an HS code in accordance with an embodiment of the present invention.

FIG. 2 is a diagram illustrating the structure of HS determination factor information in accordance with an embodiment of the present invention.

FIGS. 3 to 5 illustrate user interfaces in which the method of determining an HS code in accordance with an embodiment of the present invention has been executed.

FIG. 6 is a flowchart illustrating a method of determining an HS code in accordance with another embodiment of the present invention.

FIG. 7 illustrates a user interface screen in accordance with another embodiment of the present invention.

FIG. 8 is a block diagram illustrating an apparatus for determining an HS code in accordance with an embodiment of the present invention.

### DETAILED DESCRIPTION

A method of determining HS code in accordance with an embodiment of the present invention is described in detail below with reference to the accompanying drawings. The embodiments to be described are provided in order for those skilled in the art to easily understand the technical spirit of the present invention, and the present invention is not restricted by the embodiments. Furthermore, matters represented in the accompanying drawings have been diagrammed in order to easily describe the embodiments of the present invention, and the matters may be different from forms that are actually implemented.

Furthermore, an expression that some elements are “included” is an expression of an “open type,” and the expression simply denotes that the corresponding elements are present, but it should not be understood that additional elements are excluded.

Furthermore, an expression, such as a “first” or a “second”, is used to distinguish between a plurality of elements, and does not limit any order or other characteristics between the elements.

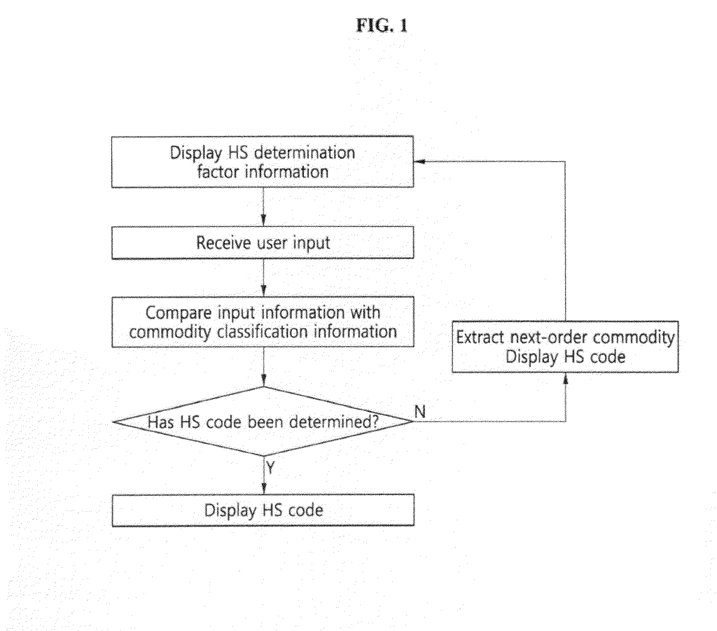

FIG. 1 is a flowchart illustrating a method of determining an HS code in accordance with an embodiment of the present invention.

In the present embodiment, the method determining an HS code includes the steps of displaying HS determination factor information that belongs to HS determination factor information and that may be selected by a user, receiving the input of the user for selecting any one of the displayed HS determination factor information, comparing the received input with commodity classification information stored in memory, and displaying a determined HS code if, as a result of the comparison, the HS code is found to be determined and returning back to the step of displaying the selectable information HS determination factor information if, as a result of the comparison, the HS code is found to be not determined.

Prior to a description of each step, the HS determination factor information, the commodity classification information, and the HS code are described below.

In an embodiment of the present invention, the HS determination factor information refers to basic information that is used to determine an HS code for a specific import/export commodity, and is basically divided into an article name and a standard by incorporating items written in an import/export declaration into the HS determination factor information. The article name includes lower information, such as a standard article name, a transaction article name, and a model name. The standard includes 13 detailed items, such as a material, a type, an external appearance of a commodity, a processing method, whether it has been assembled, a use, a size, a processing capacity, a rating voltage, a length, weight, a thickness, and a width.

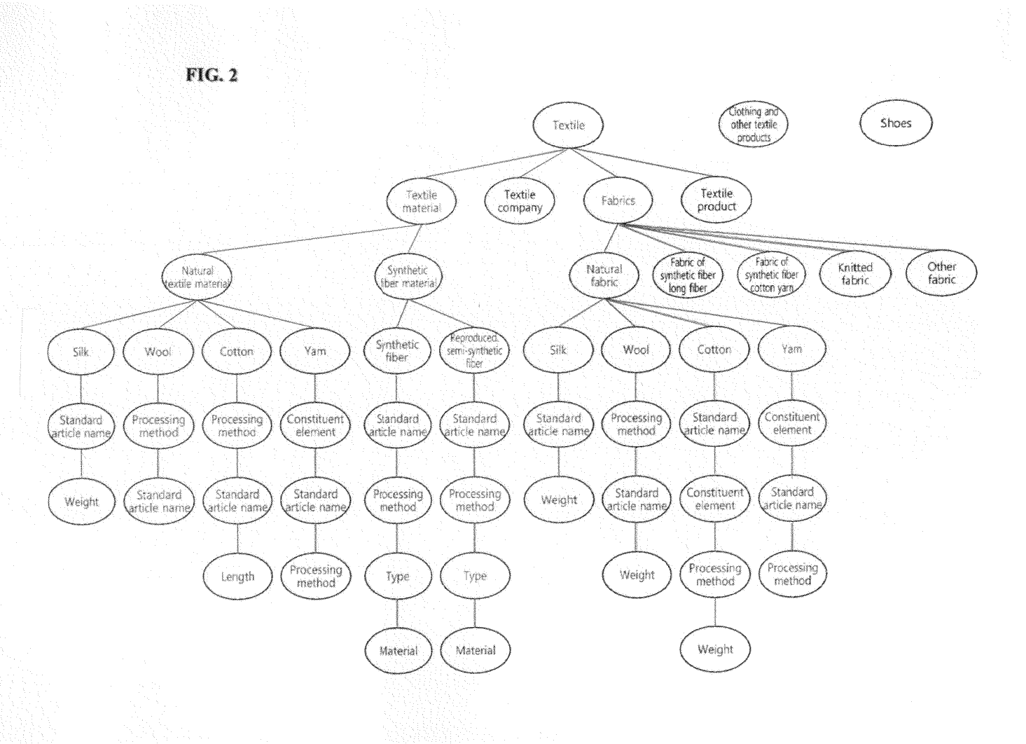

In an embodiment of the present invention, the HS determination factor information is information newly defined based on the commodity classification principle for HS codes in order to determine an HS code. That is, the HS determination factor information is a data structure that has not been present. This may be clearly checked from FIG. 2.

FIG. 2 is a diagram illustrating the structure of the HS determination factor information in accordance with an embodiment of the present invention. As described above, the HS determination factor information is basically divided into an article name group and a standard group. The article name group includes a commodity group name, a commodity (big classification), a commodity (middle classification), and 4 items (i.e., a standard article name, a trade name, a transaction article name, and a model name). A standard group node includes the aforementioned 13 detailed items. The 13 detailed items do not have priority, and may be connected through various combinations. For example, other detailed items within a standard group, such as a type, a size, and a processing capacity, may be present as lower items under a detailed item “material.” Detailed items including a material may be present as lower items under a detailed item “size.” In accordance with such a structure, if information defined in HS code is structured, specific detailed items included in information about a standard group node may be selected, and a process of determining an HS code may be performed. The reason for this is that detailed items have a hierarchical structure.

The commodity classification information means information obtained by hierarchically structuring HS determination factor information so that an HS code can be efficiently determined. In the HS determination factor information, the detailed items of a standard group node are connected in parallel so that other detailed items may be placed under each of the detailed items of the standard group node. A structure in which such detailed items are organized/hierarchically structured so that an HS code can be effectively determined is commodity classification information. The commodity classification information is summarized by basic information (i.e., HS determination factor information) and a structure obtained by hierarchically structuring the basic information (i.e., a connection structure). The connection structure is order or logic for selecting HS determination factor information in order to determine an HS code.

The commodity classification information has been newly proposed by an embodiment of the present invention and is information that has been materialized by a commodity classification expert in order to execute a method of determining an HS code in accordance with an embodiment of the present invention. If recommendation priorities for detailed items for determining detailed items for commodity classification are determined based on research and experiences of a commodity classification expert and the detailed items are selected based on the recommendation priorities, an HS code can be determined easily and rapidly.

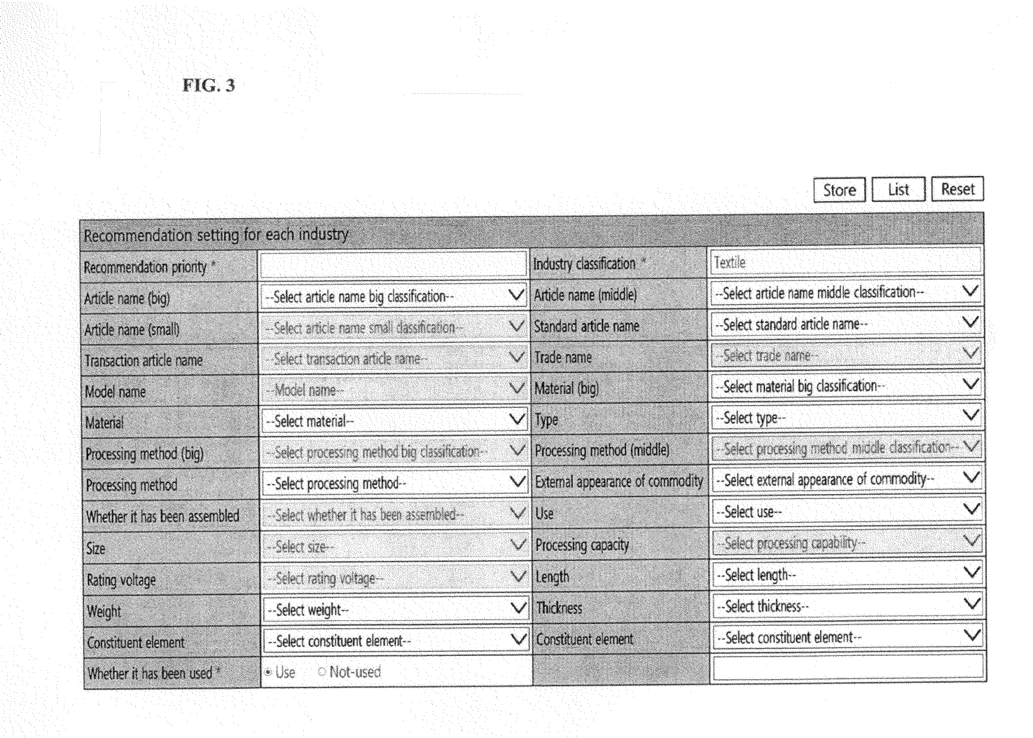

An embodiment of the present invention allows a user to determine an HS code using the aforementioned information. To this end, first, HS determination factor information that belongs to HS determination factor information and that may be selected by a user is displayed, and an example thereof is illustrated in FIG. 3. FIG. 3 illustrates a user interface executed by the display step. In the display step, various information of the HS determination factor information may be selected. particular, information that belongs to 13 standard group items and that may be selected by a user may be separately activated. If industry classification, an article name (big), and an article name (middle) are selected before determining an HS code, the HS code may be determined based on recommendation priority according to a method to be described later in accordance with an embodiment of the present invention. In order to provide a user interface for the determination, in an embodiment of the present invention, information that belongs to HS determination factor information and that may be selected by a user is displayed.

After the display step, when the user selects any one of the displayed HS determination factor information, the input of the user is received. The input for selecting a specific detailed item in some activated HS determination factor information (e.g., a standard article name, a material (big), a material, and a type) illustrated in FIG. 3 may be received.

After the input of the user is received, the received input is compared with commodity classification information stored in the memory. The aforementioned commodity classification information has been stored in the Memory. A processor compares the received HS determination factor information with the commodity classification information stored in the memory. The processor compares the received HS determination factor information with the connection structure of the commodity classification information, extracts the next-order HS determination factor information corresponding to the current input information, and provides the extracted next-order HS determination factor information in a form in which it may be viewed by the user. After the next-order HS determination factor information is extracted, a process for determining an HS code through the aforementioned display step, input step, and comparison step is further materialized.

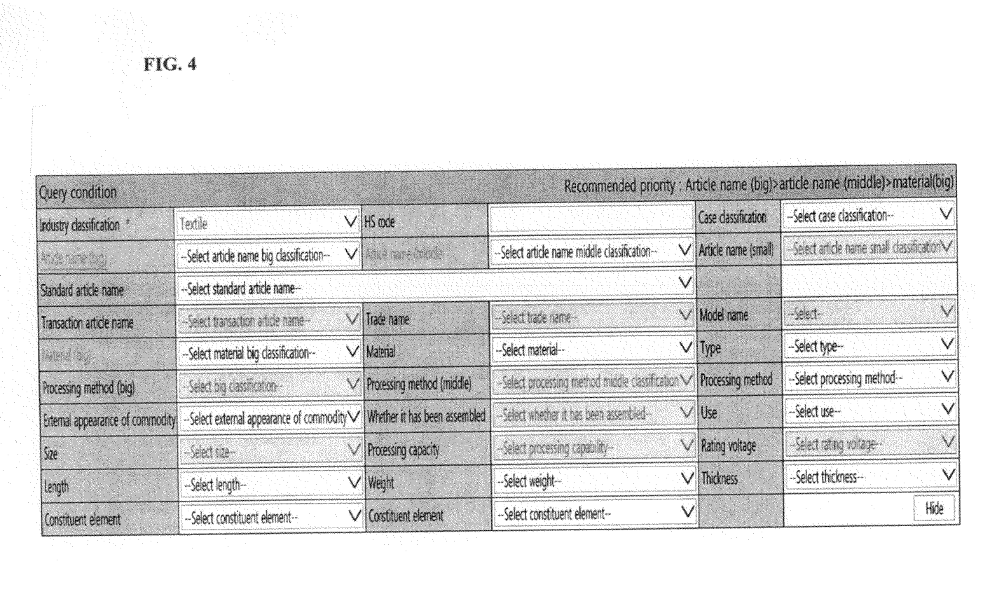

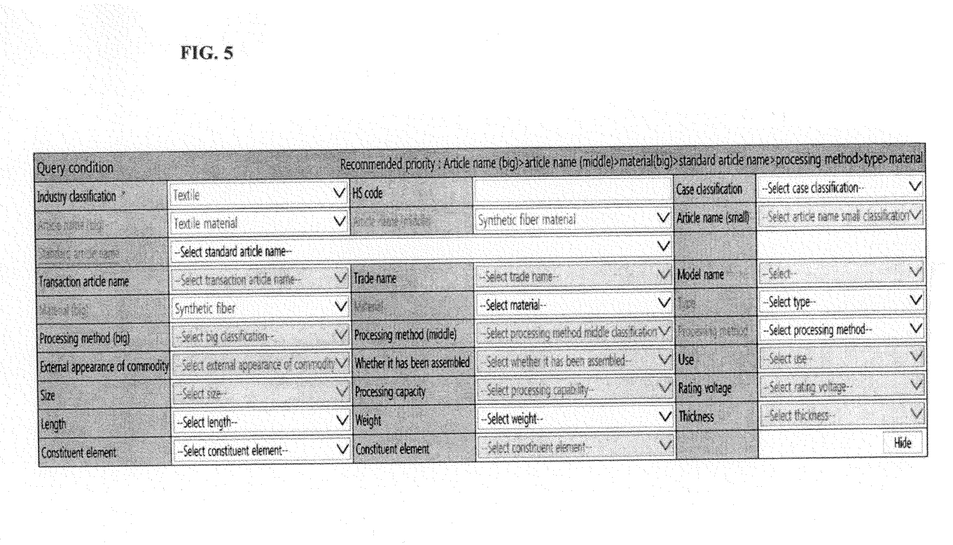

This is described with reference to FIG. 4. Referring to FIG. 4, in the state in which “industry classification ->textile” has been currently selected, an article name (big), an article name (middle), a material (big), a material, and a type are displayed as the selectable HS determination factor information. At the same time, the commodity classification information stored in the memory and a connection structure thereof are displayed at the right top of FIG. 4. In the connection structure displayed at the right top, items that enable the user to select commodity classification determination factors most rapidly and accurately when the user selects the HS determination factor information according to the order are displayed. If the user selects an article name (big) ->a textile material, an article name (middle) ->a synthetic fiber material (in the present embodiment, the comparison and operation steps are not performed because the article name (big) and the article name (middle) are not included in the HS determination factor information. However, in another embodiment, the article name (big) and the article name (middle) may also be included in the HS determination factor information) and selects a material (big) in the HS determination factor information as a synthetic fiber, the next-order HS determination factor information is extracted through the aforementioned comparison and operation steps. The process returns to the display step, and the next-order HS determination factor information is displayed to the user. A corresponding user interface screen is illustrated in FIG. 5. It may be seen from FIG. 5 that after the material (big) has been selected as a synthetic fiber, the external appearance of a commodity is deactivated and the standard article name, material, type, and processing method have been highlighted and displayed unlike in FIG. 4. The highlighted items correspond to the next-order HS determination factor information according to the connection structure of the commodity classification information.

If the HS code is determined through such a process, the determined HS code is displayed. The number of determined HS codes may be one or plural. In terms of the properties of an import/export commodity and depending on the degree that HS determination factor information is selected, various HS codes may be extracted or a single HS code may be extracted. If a plurality of HS codes is extracted, a user interface may be provided so that a user can select the most appropriate HS code.

In an embodiment of the present invention, in displaying commodity classification determination factor information that belongs to commodity classification determination factor information and that may be selected by a user, HS determination factor information that belongs to the next-order HS determination factor information and that corresponds the connection structure of commodity classification information may be highlighted and displayed. Accordingly, the user can intuitively check which items will be selected from various detailed items (i.e., HS determination factor information). In this case, the number of pieces of next-order HS determination factor information may be plural. Detailed items according to predetermined order may be activated so that an HS code that belongs to the pieces of next-order HS determination factor information and that corresponds to the connection structure of the commodity classification information can be determined rapidly and accurately. Accordingly, a user can easily perform a process of determining an HS code although he or she does not have accurate knowledge of this field. Such an example is illustrated in FIG. 5 In FIG. 5, HS determination factor information corresponding to a connection structure has been illustrated as being violet, but may be displayed using various graphic effects.

In another embodiment of the present invention, in displaying HS determination factor information that belongs to HS determination factor information and that may be selected, by a user, the connection structure of commodity classification information stored in the memory may be displayed along with the HS determination factor information. The present embodiment is illustrated in FIGS. 4 and 5. A “recommendation priority” item is displayed at the right top of FIGS. 4 and 5. The item hierarchically illustrates HS determination factor information that may be preferably selected in the future depending on the process of selecting HS determination factor information so far, a current state, and the connection structure of commodity classification information. Accordingly, if the HS determination factor information is selected according to such order, an HS code can be accurately determined in optimal order that has been researched and derived by experts. The methods of displaying the connection structure in FIGS. 4 and 5 are only illustrative, and the connection structure may be displayed various graphic effects so that a user can intuitively a flow for determining an HS code.

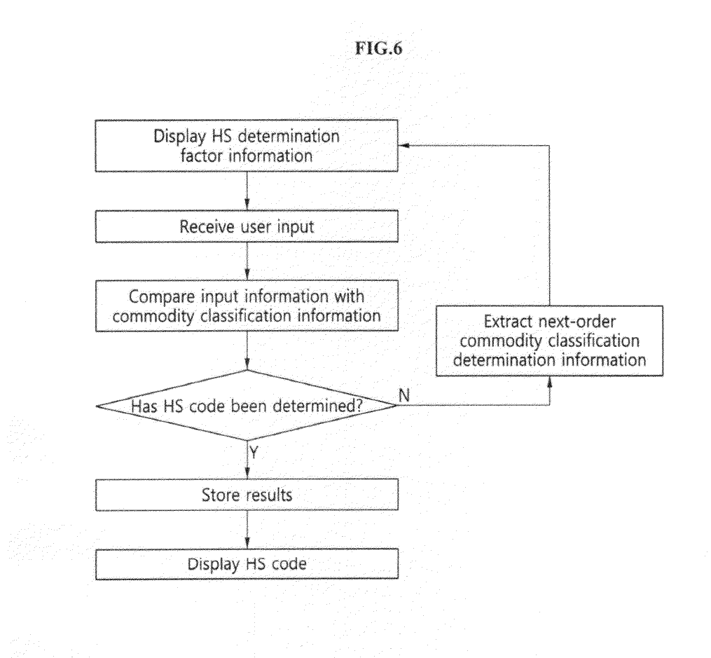

Another embodiment of the present invention is described below with reference to FIG. 6. FIG. 6 is a flowchart illustrating a method of determining an HS code in accordance with another embodiment of the present invention.

The method of determining an HS code according to the present embodiment further includes a step of matching sequentially received HS determination factor information with a determined HS code and storing the matching results in the memory if the HS code is determined after the step of comparing the received input with the commodity classification information stored in the memory in the embodiment described with reference to FIG. 1.

In the present embodiment, the process of selecting, by a user, HS determination factor information and the results of a determined HS code derived by the process may be stored so that they can be used in subsequent accumulation cases.

More specifically, if the HS determination factor information selected in the receiving step does not correspond to the connection structure and an HS code has not been determined, in the display step, HS determination factor information that belongs to the selectable HS determination factor information and that has the highest frequency of selection is highlighted and displayed based on the HS determination factor information stored in the memory and the matching information of the HS code. To this end, information about that the user has selected which HS determination factor information in each case and what HS code has been obtained based on a result of the selection is stored.

The present embodiment is further effective in the following case. The user may sequentially select the HS determination factor information based on the connection structure of the commodity classification information, but may be unaware that a corresponding import/export commodity corresponds to which one of lower items of HS determination factor information to be selected. Alternatively, the user may select the HS determination factor information for user convenience and/or other various purposes without complying with the connection structure. If the user does not comply with a predetermined connection structure as described, an HS code according to lots of experiences may be determined by providing items selected by existing users according to the present embodiment.

In another embodiment of the present invention, in displaying HS determination factor information that may be selected by a user, HS determination factor information having small number of pieces of next-order HS determination factor information may be highlighted and displayed. The present embodiment may be more effective when an existing case is not present in the state in which a user does not comply with the connection structure of commodity classification information. That is, if the HS determination factor information selected in the receiving step does not correspond to the connection structure, frequency of selection of the selectable HS determination factor information is 0 or the same, and an HS code has not been determined, in the display step, HS determination factor information that belongs to the HS determination factor information that may be selected by the user and that has a small number of pieces of next-order HS determination factor information may be highlighted and displayed. Accordingly, there are advantages in that a user's burden of selection can be reduced and a data processing load in executing the determination method of the present invention can be reduced.

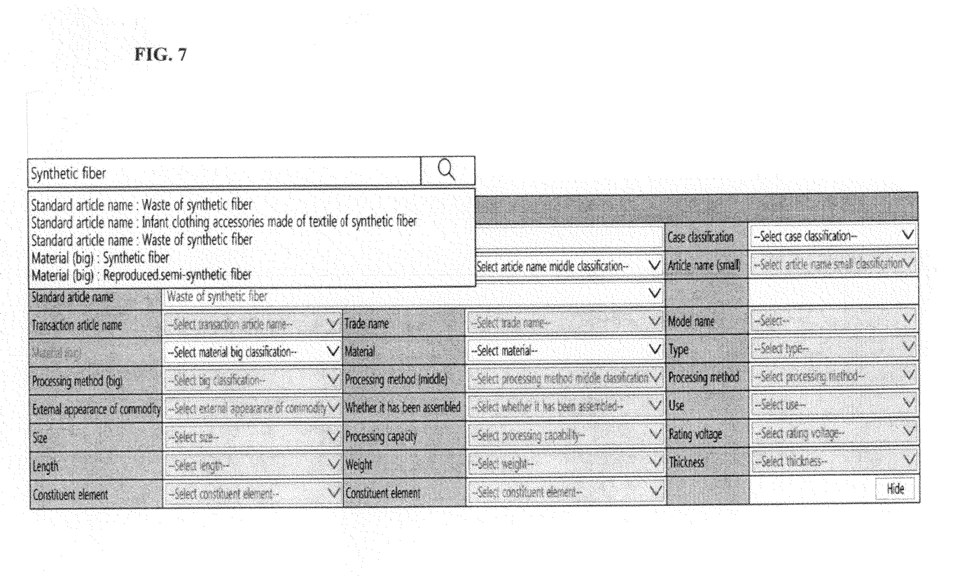

FIG. 7 illustrates a user interface screen in accordance with another embodiment of the present invention. In the present embodiment, analogous term information matched with HS determination factor information is stored in the memory. In the display step, an item retrieved based on analogous term information may be displayed along with the HS determination factor information, and HS determination factor information matched with a search word input by the user with respect to the item retrieved based on the analogous term information may be displayed.

The present embodiment is for further improving user convenience. A term included in the general commodity classification rule used to determine an HS code may be a term that is not frequently used. That is, a term frequently used in the industry may be different from a term defined in the general commodity classification rule. As a result, HS determination factor information to be selected by a user may not be selected as a term that is known to the user. In this case, in an embodiment of the present invention, terms defined in the general commodity classification rule are matched with terms frequently used in the industry so that the user can use the method of the present invention, and the matched terms are displayed in the same user interface as the HS determination factor information. Accordingly, commodity classification can be provided so that it is determined easily and conveniently.

The method of determining an HS code according to the aforementioned various embodiments of the present invention may be fabricated and implemented in the form of a program to be executed by a computer. That is, the present invention may be fabricated in the form of a computer program and may be implemented in the form of a computer-readable recording medium on which the computer program has been recorded.

Furthermore, the present invention has been construed as including a computer program stored in the aforementioned recording medium. That is, behaviors, such as the production, use, and transfer of the computer program stored in the recording medium should be construed as executing the present invention.

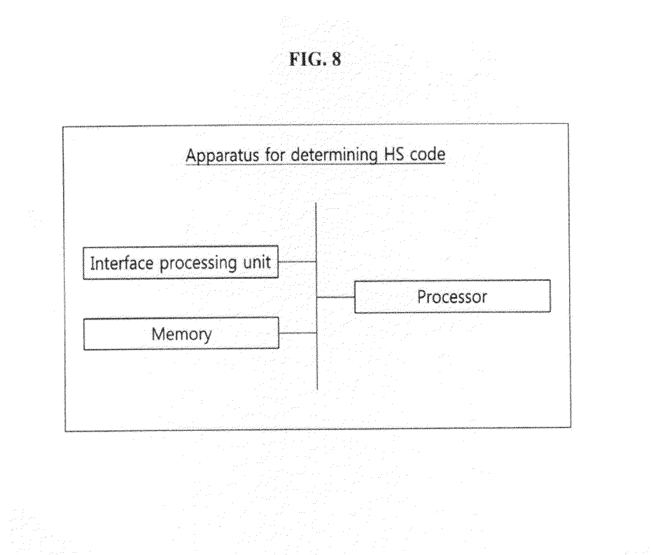

FIG. 8 is a block diagram illustrating an apparatus for determining an HS code in accordance with an embodiment of the present invention.

In the present embodiment, the apparatus for determining an HS code includes an interface processing unit configured to provide HS determination factor information so that a user may select the HS determination factor information, receive selected HS determination factor information from the user, deliver the received HS determination factor information to a processor or the memory, and provide HS determination factor information or an HS code processed by the processor in a form in which the HS determination factor information or HS code is capable of being checked by the user, the processor configured to compare the HS determination factor information received from the interface processing unit with commodity classification information stored in the memory, calculate next-order HS determination factor information or HS code corresponding to the received HS determination factor information, and deliver the calculated next-order HS determination factor information or HS code to the interface processing unit or the memory, and the memory configured to store a commodity classification connection structure corresponding to the HS determination factor information and an HS code corresponding to the connection structure.

The interface processing unit means an element for displaying a result according to various operation of the present invention to a user and receiving and processing the input of the user. If the apparatus for determining an HS code is implemented in a single computing apparatus in a program form, input/output means, for example, a keyboard, a mouse, and a monitor may correspond to the interface processing unit. A graphic processing device capable of such input/output may also correspond to the interface processing unit. If the apparatus for determining an HS code is implemented as a separate computing device and a user accesses the apparatus for determining an HS code based on a web and determines an HS code, a communication unit in addition to a graphic processing device for implementing user interfaces may also correspond to the interface processing unit.

The processor is an element for performing the various comparisons, operation, and analyses aforementioned in the aforementioned embodiment. A CPU capable of data processing may be implemented in a computing apparatus for implementing the apparatus for determining an HS code.

The memory is an element for storing data, and may include various storage media that may be mounted on and connected to a computing apparatus. The memory in accordance with an embodiment of the present invention may store information received from an input unit and information calculated by the processor.

In accordance with an embodiment of the present invention, a user can select HS determination factor information proposed using an intuitive interface and then determine an HS code. In particular, an objective determination result can be rapidly obtained because an HS code can be determined using existing know-how and cases performed by other users.

Furthermore, an HS code can be determined much conveniently compared to a prior art because the HS code can be determined although a term is not used in the principle of commodity classification, such as a custom tariff schedule and a custom tariff schedule explanation.

The embodiments of the present invention have been disclosed for illustrative purposes, and modification, changes, and additions performed by those skilled in the art to which the present invention pertains without departing from the scope of the present invention should be construed as belonging to the claims.

What is claimed is:

1. A method of determining an HS code, comprising steps of:
displaying information HS determination factor information that belongs to HS determination factor information and that is able to be selected by a user;
receiving an input of the user for selecting any one of the displayed HS determination factor information;
comparing the received input with commodity classification information stored in memory; and
displaying a determined HS code if, as a result of the comparison, the HS code is found to be determined and returning back to the step of displaying the selectable information HS determination factor information if, as a result of the comparison, the HS code is found to be not determined,
wherein a connection structure of commodity classification information corresponding to the HS determination factor information is stored in the memory,
the comparison step comprises extracting next-order HS determination factor information included in the connection structure of the commodity classification information corresponding to the received HS determination factor information, and
the display step comprises displaying the extracted next-order HS determination factor information.

2. The method of claim 1, wherein the display step comprises highlighting and displaying HS determination factor information that belongs to the next-order HS determination factor information and that corresponds to the connection structure.

3. The method of claim 1, wherein the display step comprises displaying the connection structure of the commodity classification information stored in the memory along with the HS determination factor information.

4. The method of claim 1, further comprising a step of matching sequentially received HS determination factor information with the determined HS code and storing the matched HS determination factor information and HS code in the memory if the HS code is determined after the comparison step.

5. The method of claim 4, wherein if the HS determination factor information selected in the receiving step does not correspond to the connection structure and the HS code has not been determined, the display step comprises highlighting and displaying HS determination factor information that belongs to the HS determination factor information capable of being selected by the user and that has a highest frequency of selection based on the HS determination factor information stored in the memory and the matching information of the HS code.

6. The method of claim 1, wherein the display step comprises highlighting and displaying HS determination factor information that belongs to the HS determination factor information capable of being selected by the user and that has a small number of pieces of the next-order HS determination factor information.

7. The method of claim 5, wherein if the HS determination factor information selected in the receiving step does not correspond to the connection structure, frequency of selection of the HS determination factor information capable of being selected by the user is 0 or identical, and the HS code has not been determined, the display step comprises highlighting and displaying HS determination factor information that belongs to the HS determination factor information capable of being selected by the user and that has a small number of pieces of the next-order HS determination factor information.

8. The method of claim 1, wherein:
analogous term information matched with the HS determination factor information is stored in the memory, and
the display step comprises displaying an analogous term information search item along with the HS determination factor information and displaying HS determination factor information matched by a search word that is input to the analogous term information search item by the user.

9. A computer-readable recording medium on which a program for executing a method of determining an HS code according to claim 1 has been recorded.

10. A computer program capable of being stored in a medium for executing a method of determining an HS code according to claim 1.

11. An apparatus for determining an HS code, comprising:
an interface processing unit configured to provide HS determination factor information so that a user is able to select the HS determination factor information, receive selected HS determination factor information from the user, deliver the received HS determination factor information to a processor or memory, and provide HS determination factor information or an HS code processed by the processor in a form in which the HS determination factor information or HS code is capable of being checked by the user;
the processor configured to compare the HS determination factor information received from the interface processing unit with commodity classification information stored in the memory, calculate next-order HS determination factor information or HS code corresponding to the received HS determination factor information, and deliver the calculated next-order HS determination factor information or HS code to the interface processing unit or the memory; and
the memory configured to store a commodity classification connection structure corresponding to the HS determination factor information and an HS code corresponding to the connection structure.
